(19) United States
(12) Patent Application Publication
(10) Pub. No.: US 2008/0141109 A1
(43) Pub. Date: Jun. 12, 2008

(54) OSD system for achieving user-defined display mode and method for controlling the same

(75) Inventors: Ying Chen, Shenzhen (CN); Jian-Feng Wang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/001,576

(22) Filed: Dec. 11, 2007

(30) Foreign Application Priority Data
Dec. 11, 2006 (TW) 95146233

(51) Int. Cl. G06F 17/00; G06F 3/048

(52) U.S. Cl. 715/203; 715/806

(57) ABSTRACT

An exemplary OSD system (10) for a display device is provided. The OSD system includes an OSD menu (12), a memory (13), and a timing controller (14). The OSD menu is configured for building user-defined display modes for the display device. The memory is configured for saving the user-defined display modes and current timing parameters, and setting a relationship between the display mode and the current timing parameters according to a control signal of the OSD menu. The timing controller is configured for calling a display mode which is linked with the current timing parameters, and setting the display mode as a current display mode. A method for controlling the on-screen display is also provide.

### FIELD OF THE INVENTION

The present invention relates to on-screen display (OSD) system of display devices and methods for controlling the OSD system; and particularly to an OSD system for achieving user-defined display modes and a method for controlling the OSD system.

### BACKGROUND

In general, a monitor is a display device that is used with an apparatus such as a computer in order to show data generated by the computer. Most popular monitors can be classified to CRT (Cathode Ray Tube) monitors and LCD (Liquid Crystal Display) monitors.

Some such monitors have an OSD function for displaying information relating to adjusting of display characteristics of video signal transmitted from the computer as well as information about the monitor itself. The OSD activated on the screen of the monitor generally includes a plurality of menus for altering information associated with a shape, a color, etc., of the display. Thus, the monitor can works in a preferred display mode.

However, the OSD system generally includes several fixed display modes, and can only memory the current user-defined display mode. The former user-defined display modes are omitted. Users cannot store different user-defined display modes. Thus, users may spend much time to adjust the display parameters to achieve variety of preferred display modes. This results in inconvenient operation and wasted time.

Therefore, a new OSD system and a method for controlling the OSD system that can overcome the above-described problems are desired.

### SUMMARY

An exemplary on-screen display (OSD) system for a display device is provided. The on-screen display (OSD) system includes an OSD menu, a memory, and a timing controller. The OSD menu is configured for building user-defined display modes for the display device. The memory is configured for saving the user-defined display modes and current timing parameters of the display device, and linking the display mode with the current timing parameters according to a control signal of the OSD menu. The timing controller is configured for calling a display mode which is linked with the current timing parameters, and setting the display mode as a current display mode.

An on-screen display controlling method for a display device is provided. The display device includes an on-screen display system. The on-screen display system includes an OSD menu, a memory, and a timing controller. The on-screen display controlling method includes following steps. a, building up user-defined display modes for the display device through the OSD menu, and saving the new display modes in the memory; b, linking the display modes with the current timing parameters; c, detecting whether the current timing parameters are linked with a display mode, while the current timing parameters are linked with a display mode, setting the display mode as the current display mode of the display device; while the current timing parameters are not linked with a display mode, setting a default display mode as the current display mode of the display device.

Other novel features and advantages will become more apparent from the following detailed description when taken in conjunction with the accompanying drawings.

### BRIEF DESCRIPTION OF THE DRAWINGS

FIG. 1 is a block diagram of an OSD system of a display device according to a preferred embodiment of the present invention.

FIG. 2 is an expanded diagram of an OSD menu of the OSD system of FIG. 1.

FIG. 3 is flow chart of a method for controlling the OSD system.

### DETAILED DESCRIPTION OF PREFERRED EMBODIMENTS

FIG. 1 is a block diagram of an OSD system of a display device according to a preferred embodiment of the present invention. The OSD system 10 is used for providing multi display modes for a display unit 20. The OSD system 10 includes an inputting unit 11, an OSD menu 12, a memory 13, a timing controller 14, a micro-controller unit (MCU) 15, and a video signal processing unit 17.

The inputting unit 11 is used for adjusting the OSD menu 12. The inputting unit 11 may be a plurality of push buttons, turn buttons, a key board, a mouse, and the like. The OSD menu 12 is a human-machine interactive interface. Users adjust display parameters of the display unit 20 through the OSD menu 12, in order to achieve varied display modes. Users can also input controlling signals to the memory 13 through the OSD menu 12.

The memory 13 is a non-volatile random access memory (NVRAM), which can for example be an electrically erasable programmable read-only memory (EEPROM). The memory 13 is used for storing parameters of the varied display modes and timing parameters that determining an output of the timing controller 14. The memory 13 can also call a program to link a display mode with the current timing parameters according to the control signal of the OSD menu 12. The display modes include default display modes, and user-defined display modes which are defined and stored by users. The timing parameters includes related address and corresponding data building time, related address and corresponding data retention time, system cycle period, and the like.

The MCU 15 continuously checks the relationships of the varied display modes and current timing parameters, and then outputs a trigger signal to drive the timing controller 14. The timing controller 14 reads parameters of the corresponding display mode from the memory 13 according to the control signal of the OSD menu 12, and sends the parameters of the display mode to the video signal processing unit 17. Then the video signal processing unit 17 processes and outputs display signals to the display unit 20. Accordingly, the display unit 20 works in the corresponding display mode.

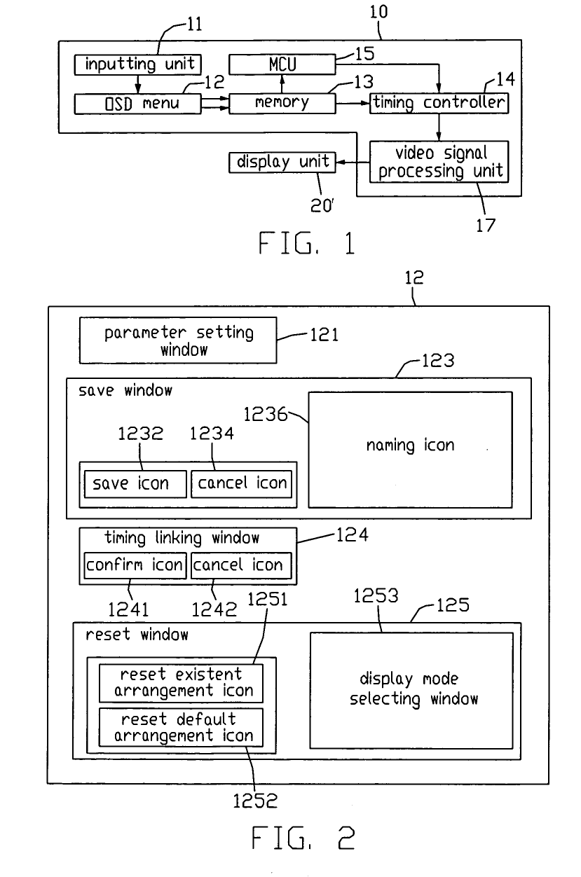

FIG. 2 is an expanded diagram of the OSD menu 12. The OSD menu 12 includes a parameter setting window 121, a save window 123, a timing relating window 124, and a reset window 125.

The parameter setting window 121 is used for displaying and setting display parameters of the display unit 20, such as brightness, contrast ratio, color temperature, standard color, chroma, language, and the like. Users adjust the parameters through the inputting unit 11, in order to achieve varied display modes.

The save window 123 is used for saving the current display mode as a new user-defined display mode. The save window 123 includes a save icon 1232, a cancel icon 1234, and a naming icon 1236. When the display parameters are changed, users select the save icon 1232 to save the display parameters. The new user-defined display mode can be named through the naming icon 1236. The saved display parameters are stored as a new user-defined display mode in the memory 13. If the cancel icon 1234 is selected, users give up saving the display parameters.

The timing linking window 124 is used for linking the new user-defined display mode with the current timing parameters. The timing linking window 124 includes a confirm icon 1241 and a cancel icon 1242. If the confirm icon 1241 is selected, the new user-defined display mode is linked with the current timing parameters. If the cancel icon 1242 is selected, the new user-defined display mode is not set to be linked with the current timing parameters.

The reset window 125 is used for resetting the current display mode to a default display mode or a user-defined display mode. The reset window 125 includes a reset existent arrangement icon 1251, a reset default arrangement icon 1252, and a display mode selecting window 1253. The reset existent arrangement icon 1251 is used for executing existent display modes. The reset default arrangement icon 1252 is used for executing default display modes. The display mode selecting window 1253 is a sub-window of the reset existent arrangement icon 1251. If the reset existent arrangement icon 1251 is selected, the display mode selecting window 1253 is popped up to exhibit the multiple saved display modes. Thus, users can select any one of the display modes to be the current display mode. If the reset default arrangement icon 1252 is selected, the default display mode is set to be the current display mode.

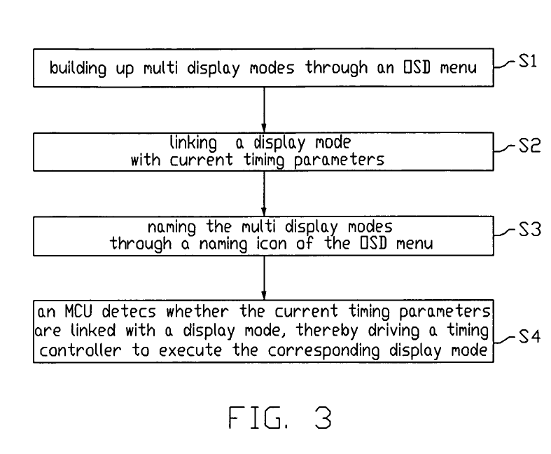

FIG. 3 is a flow chart of the method for controlling the OSD system 10. The OSD controlling method includes: step 1, building up multi display modes through an OSD menu; step 2, linking a display mode with current timing parameters; step 3, naming the multi display modes through a naming icon of the OSD menu; step 4, an MCU detects whether the current timing parameters are linked to a display mode, thereby driving a timing controller to execute the corresponding display mode.

In step S1, an user adjusts current display parameters displayed in the parameter setting window 121 through the inputting unit 11. Then the user can select the save icon 1232 of the save window 123 to save the changed display parameters as a new display mode in the memory 13. In addition, if the display parameters are not preferred, the user can select the cancel icon 1234 to give up the changed display parameters. The display parameters maintain the same until a new display mode is executed. The above-described actions are repeated, in order to build up and save multiple user-defined display modes.

In step S2, the user selects the timing linking window 124 of the OSD menu 12 to determine whether linking a display mode with the current timing parameters. If the user selects the confirm icon 1241, the OSD menu 12 outputs a control signal to the memory 13 to call a corresponding program. The program is used for linking the display mode and the current timing parameters together. If the user selects the cancel icon 1242, the display mode is not linked the current timing parameters.

In step S3, the display modes is named through the naming icon 1236 of the OSD menu 12. Thus the display modes can be conveniently recognized and used.

In step S4, the MCU 15 detects whether the timing parameters are linked with a display mode, thereby driving the timing controller 14 to call the corresponding display mode.

When a display device using the OSD system 10 begins work next time, the MCU 15 firstly detects whether an existent display mode is linked with the current timing parameters. If an existent display mode is linked with the current timing parameters, the MCU 15 outputs a trigger signal to drive the timing controller 14 to read the current timing parameters and corresponding display mode. Then the parameters of the display mode are sent to the video signal processing unit 17 to drive the display unit 20. Accordingly, the display unit 20 works in the corresponding display mode.

If the MCU 15 detects that the current timing parameters are not linked with any of the existent display modes, the display device automatically pops up the reset window 125 that includes the reset existent arrangement icon 1251 and the reset default arrangement icon 1252. When the reset existent arrangement icon 1251 is selected, the display mode selecting window 1253 is popped up. The display mode selecting window 1253 exhibits multi display modes. When one of the display modes is selected, the MCU 15 calls a program corresponding to the display mode from the memory 13, and then links the display mode with the current timing parameters. The MCU 15 processes the display mode and outputs a trigger signal to the timing controller 14. The timing controller 14 reads the program corresponding to the display mode and sets the display mode as the current display mode. On the contrary, if the reset default arrangement icon 1252 is selected, the OSD menu 12 outputs a control signal to call a corresponding program from the memory 13. Thus, the default display mode is linked with the current timing parameters. Then the MCU 15 outputs a trigger signal to the timing controller 14 to read information about the current timing parameters and the default display mode from the memory 13. The default display mode is then set as the current display mode.

In summary, the OSD system 10 is capable of storing multiple display modes. The display modes not only include default display modes, but also include user-defined display modes which are defined and preferred by the users. Moreover, each user-defined display mode can also be set as the current display mode. Accordingly, the OSD system 10 gives the users more convenience and freedom to set and change the display modes of the display unit 20.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. An on-screen display (OSD) system for a display device, comprising:
an OSD menu configured for building up user-defined display modes for the display device;
a memory configured for saving the user-defined display modes and current timing parameters of the display device, and calling a program according to a control signal of the OSD menu to link the display mode with the current timing parameters;
a timing controller configured for executing a display mode which is linked with the current timing parameters.

2. The on-screen display system as claimed in claim 1, wherein the OSD menu comprises a parameter setting window configured for displaying and setting display parameters of the display device.

3. The on-screen display system as claimed in claim 2, wherein the OSD menu further comprises a save window configured for saving the current display parameters as a new display mode.

4. The on-screen display system as claimed in claim 3, wherein the save window comprises a save icon, a cancel icon, and a naming icon, the new display mode being saved in the memory while the save icon is selected, the new display mode being named through the naming icon, and the display parameters maintaining the same while the cancel icon is selected.

5. The on-screen display system as claimed in claim 3, wherein the OSD menu further comprises a timing linking window configured for linking the new display mode with the timing controller.

6. The on-screen display system as claimed in claim 1, wherein the OSD menu further comprises a reset window configured for determining whether changing the current display mode to the default display mode or a new display mode or a user-defined display mode.

7. The on-screen display system as claimed in claim 6, wherein the reset window comprises a reset existent arrangement icon and a reset default arrangement icon, and a display mode selecting window, the display mode selecting window being a sub-window of the reset existent arrangement icon, the display mode selecting window being popped up to provide various user-defined display modes while the reset existent arrangement icon is selected, and the display device working in the default display mode while the reset default arrangement icon is selected.

8. The on-screen display system as claimed in claim 1, further comprising a micro-controller unit, the micro-controller unit being configured for detecting whether the current timing parameters are linked with a display mode, while a display mode is linked with the current timing parameters, the micro-controller unit outputting a trigger signal to the timing controller for executing the corresponding display mode.

9. The on-screen display system as claimed in claim 1, further comprising an inputting unit configured for inputting adjusting signal to the OSD system.

10. The on-screen display system as claimed in claim 1, wherein the memory is a non-volatile random access memory.

11. The on-screen display system as claimed in claim 1, wherein the memory is a electrically erasable programmable read-only memory.

12. The on-screen display system as claimed in claim 1, further comprising a video signal processing unit configured for controlling display images of the display device.

13. An on-screen display controlling method for a display device, the display device comprising an on-screen display system, the on-screen display system comprising an OSD menu, a memory, and a timing controller, the on-screen display controlling method comprising following steps:
step a, building up user-defined display modes for the display device through the OSD menu, and saving the new display modes in the memory;
step b, linking one of the display modes saved in the memory with the current timing parameters;
step c, detecting whether the current timing parameters are linked with a display mode, while the current timing parameters are linked with a display mode, setting the display mode as the current display mode of the display device; while the current timing parameters are not linked with a display mode, setting a default display mode as the current display mode of the display device.

14. The on-screen display controlling method as claimed in claim 13, wherein in the step a, adjusting display parameters of the display device through the OSD menu, thereby building up the user-defined display mode.

15. The on-screen display controlling method as claimed in claim 14, wherein after the step a, further comprising a step of naming and saving the user-defined display modes.

16. The on-screen display controlling method as claimed in claim 15, wherein in the step b, the OSD menu outputs a control signal to the memory, and the memory calls a corresponding program to link one of the display modes with the current timing parameter.

17. The on-screen display controlling method as claimed in claim 16, wherein the on-screen display system further comprises a micro-controller unit, the micro-controller unit being configured for detecting whether the current timing parameters are linked with a display mode, while a display mode is linked with the current timing parameters, the micro-controller unit outputting a trigger signal to the timing controller for executing the corresponding display mode.

18. The on-screen display controlling method as claimed in claim 17, wherein the timing controller reads information corresponding to the display mode from the memory, and executing the display mode.

19. The on-screen display controlling method as claimed in claim 17, wherein the display mode is one of the user-defined display modes.
